(19) United States
(12) Patent Application Publication
(10) Pub. No.: US 2002/0107696 A1
(43) Pub. Date: Aug. 8, 2002

(54) Enabling voice control of voice-controlled apparatus

(76) Inventors: Andrew Thomas, Atherton, CA (US); Stephen John Hinde, Bristol (GB)

Correspondence Address: c/o LADAS & PARRY, Suite 2100, 5670 Wilshire Boulevard, Los Angeles, CA, 90036-5679, US

(21) Appl. No.: 10/005,375

(22) Filed: Dec. 4, 2001

(30) Foreign Application Priority Data
Dec. 5, 2000 (GB) 0029573.3

(51) Int. Cl. G10L 21/00

(52) U.S. Cl. 704/275

(57) ABSTRACT

Voice-controlled apparatus is provided which minimises the risk of activating more than one such apparatus at a time where multiple voice-controlled apparatus exist in close proximity. To start voice control of the apparatus, a user needs to be touching the apparatus when speaking. Preferably, after the user stops touching the apparatus, continuing voice control can only be effected whilst the user continues speaking without breaks longer than a predetermined duration. The touch sensitive area of the apparatus is made of substantial size in the top front part of the apparatus.

### FIELD OF THE INVENTION

The present invention relates to the enabling of the voice control of voice-controlled apparatus.

### BACKGROUND OF THE INVENTION

Voice control of apparatus is becoming more common and there are now well developed technologies for speech recognition particularly in contexts that only require small vocabularies.

However, a problem exists where there are multiple voice-controlled apparatus in close proximity since their vocabularies are likely to overlap giving rise to the possibility of several different pieces of apparatus responding to the same voice command.

It is known from U.S. Pat. No. 5,991,726 to provide a proximity sensor on a piece of voice-controlled industrial machinery or equipment. Activation of the machinery or equipment by voice can only be effected if a person is standing nearby. However, pieces of industrial machinery or equipment of the type being considered are generally not closely packed so that whilst the proximity sensor has the effect of making voice control specific to the item concerned in that context, the same would not be true for voice controlled kitchen appliances as in the latter case the detection zones of the proximity sensors are likely to overlap.

One way of overcoming the problem of voice control activating multiple pieces of apparatus, is to require each voice command to be immediately preceded by speaking the name of the specific apparatus it is wished to control so that only that apparatus takes notice of the following command. This approach is not, however, user friendly and users frequently forget to follow such a command protocol, particularly when in a hurry.

It is an object of the present invention to provide a more user-friendly way of minimising the risk of unwanted activation of multiple voice-controlled apparatus by the same verbal command.

### SUMMARY OF THE INVENTION

According to one aspect of the present invention, there is provided a method of enabling voice control of voice-controlled apparatus, involving:

(a) detecting when the user is touching at least a predetermined portion of the apparatus;

(b) initially enabling the apparatus for voice control only when the user is detected in (a) as touching the apparatus.

According to another aspect of the present invention, there is provided apparatus with a voice-control user interface comprising:

a speech recognition subsystem for recognising user voice commands for controlling the apparatus;

a touch sensor for detecting when the user is touching at least a predetermined portion of the apparatus; and

enablement control means for initially enabling the apparatus for voice control only if the touch sensor detects that the user is touching the apparatus.

### BRIEF DESCRIPTION OF THE DRAWINGS

A method and apparatus embodying the invention will now be described, by way of non-limiting example, with reference to the accompanying diagrammatic drawings, in which:

FIG. 1 is a diagram illustrating a room equipped with three voice-controlled devices embodying the invention;

FIG. 2 is a diagram showing a FIG. 1 device with a touch-sensitive zone along its front edge; and

FIG. 3 is a diagram showing a FIG. 1 device with a touch-sensitive fabric zone on its top surface.

### BEST MODE OF CARRYING OUT THE INVENTION

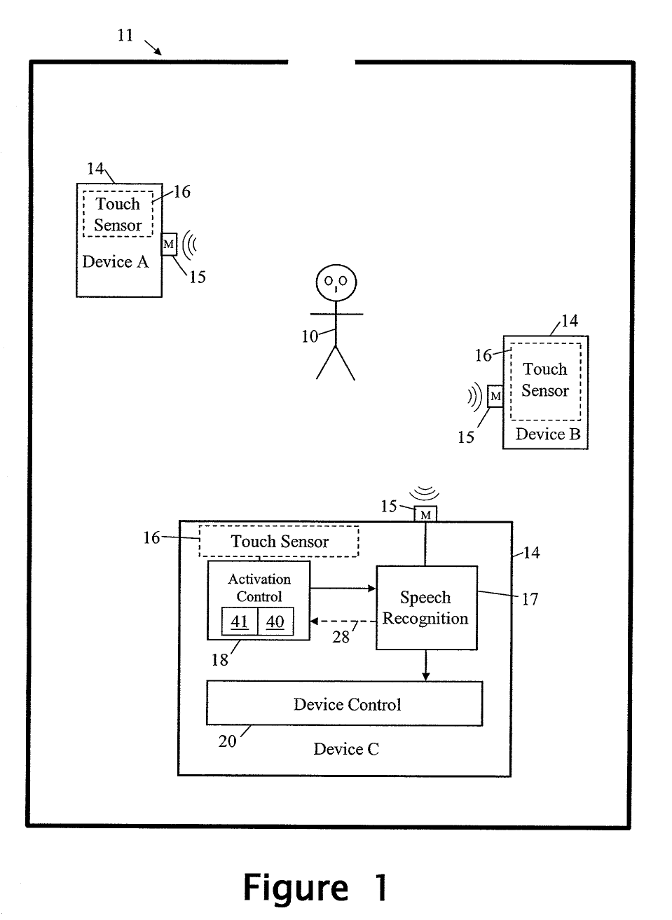

FIG. 1 shows a work space 11 in which a user 10 is present. Within the space 11 are three voice-controlled devices 14 (hereinafter referred to as devices A, B and C respectively) each with different functionality but each provided with a similar user interface subsystem permitting voice control of the device by the user.

More particularly, and with reference to device C, the user-interface subsystem comprises a microphone 15 feeding a speech recognition unit 17 adapted to recognise a small vocabulary of command words associated with the device, a touch sensor 16, and an activation control block 18. The output of the speech recognition unit is passed to a control block 20 for controlling the main functionality of the device itself (the control block can also receive input from other types of input controls such as mechanical switches so as to provide an alternative to the voice-controlled interface).

If the user 10 just speaks without touching touch sensor 16, the activation control block keeps the speech recogniser in an inhibited state and the latter therefore produces no output to the device control block. However, upon the user touching the sensor 16 the activation control block 18 enables the speech recognition unit to receive and interpret voice commands from the user. This initial enablement only exists whilst the sensor is touched, possibly extended for a short period (e.g. one second) after touching ceases. Only if the user speaks during this initial enablement phase does the activation control block 18 continue to enable the speech recognition unit 17 after the user stops touching sensor 16. For this purpose (and as indicated by dashed arrow 28 in FIG. 1), the block 25 is fed with an output from the speech recognition unit 17 that simply indicates whether or not the user is speaking (here intended to encompass the whole range of sounds that humans can make). A delayed-disablement block 40 of control block 18 is activated if the output 28 indicates that the user is speaking during the initial enablement phase (that is, when the user is touching the sensor 16). The delayed-disablement block 40 when activated ensures that the speech recognition unit 17 continues to be enabled, after the user ceases touching the sensor 16, but only whilst the user continues speaking and for a limited further period timed by timer 41 (and, for example, of 10 seconds duration) in case the user wishes to speak again to the device. If the user starts talking again in this period, the speech recognition unit interprets the input and also indicates to block 18 that the user is speaking again; in this case, block 40 continues its enablement of unit 17 and resets timing out of the aforesaid limited further period of silence allowed following speech cessation.

In this manner, the user can easily ensure that only one device at a time is responsive to voice control.

With regard to the touch sensor 16 of each device 14, this sensor can be implemented using any suitable technology such as capacitive sensor, pressure sensor, resistive sensor, thermal sensor, electrostatic sensor etc; in fact, even a switch with a mechanical closing/opening action can be used. The sensor preferably has an active area comprising one or more zones which together occupy a substantial part of the upper part of the device. By substantial part is meant an area at least that of an adult human hand so as to enable a user to touch the area without having to look closely.

Indeed, the active area is advantageously chosen to be a part of the device outer surface upon which a user might naturally place their hand, such as that

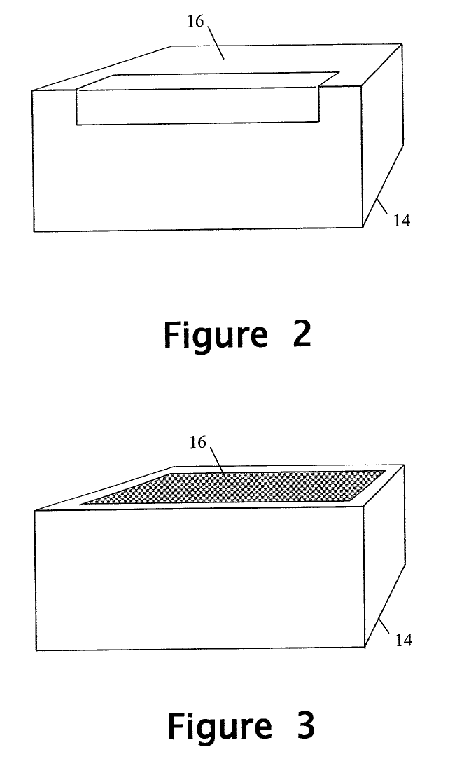

a zone along a top front edge of the apparatus (see FIG. 2);

a zone along a top side edge of the apparatus;

a zone occupying a major part of the front third of the top of the apparatus.

In order to minimise the risk of accidental operation of the touch sensor, the sensor preferably requires for its operation a touch with at least one predetermined, non-personal, characteristic such as a minimum touch pressure in a particular direction. In this respect, the active area can be a switch plate mechanically configured to resist accidental activation by a user passing by the device rather than approaching towards the device; thus the switch plate can be arranged to pivot about an axis parallel to a top front edge of the device.

To encourage users to become used to touching the devices 14, the touch sensors can be given fabric/clothe covered active areas (see FIG. 3)—in particular, a material with a pile that is pleasant to stroke can be used (and, indeed, activation of the sensor can be made dependent on a stroking action, for example, by sensing bending of the pile fibres or electrostatic charge detection where an appropriate pile material is used).

Many other variants are, of course, possible to the arrangement described above. For example, the activation control block could be arranged to enable the speech recognition unit only whilst the sensor 16 is being touched.

1. A method of enabling voice control of voice-controlled apparatus, involving:
(a) detecting when the user is touching at least a predetermined portion of the apparatus;
(b) initially enabling the apparatus for voice control only when the user is detected in (a) as touching the apparatus.

2. A method according to claim 1, wherein the apparatus only remains enabled for voice control whilst the user continues to be detected in (a) as touching the apparatus.

3. A method according to claim 1, further involving:
detecting when the user is speaking, and
where the user is detected as speaking whilst the apparatus is initially enabled for voice control, continuing enablement of the apparatus for voice control following the user ceasing to touch the apparatus but only whilst the user continues speaking and for a timeout period thereafter, recommencement of speaking by the user during this timeout period continuing enablement of voice control with timing of the timeout period being reset.

4. A method according to claim 1, wherein (a) requires the user to touch an activation area of the apparatus comprising one or more zones which together occupy a substantial part of the upper part of the apparatus.

5. A method according to claim 4, wherein said substantial part is at least the area of a hand.

6. A method according to claim 4, wherein said activation area comprises one or more of the following zones intended for hand contact:
a zone along a top front edge of the apparatus;
a zone along a top side edge of the apparatus;
a zone occupying a major part of the front third of the top of the apparatus.

7. A method according to claim 1, wherein (a) requires a touch with at least one predetermined non-personal characteristic.

8. A method according to claim 7, wherein said at least one predetermined characteristic is a minimum touch pressure in a particular direction.

9. A method according to claim 8, wherein said touch is detected using a switch plate mechanically configured to resist accidental activation by a user passing by the apparatus rather than approaching towards the apparatus.

10. A method according to claim 1, wherein (a) involves the user stroking a particular zone of the apparatus.

11. Apparatus provided with a voice-control user interface comprising:
a speech recognition subsystem for recognising user voice commands for controlling the apparatus;
a touch sensor for detecting when the user is touching at least a predetermined portion of the apparatus; and
enablement control means for initially enabling the apparatus for voice control only if the touch sensor detects that the user is touching the apparatus.

12. Apparatus according to claim 11, wherein the control means is operative to keep the apparatus enabled for voice control only whilst the touch sensor continues to detect the user touching the apparatus.

13. Apparatus according to claim 11, further comprising a speaking detector for detecting when a user is speaking, the control means comprising:
initial-enablement means for effecting the said initial enabling of the apparatus for voice control;
delayed-disablement means including timing means for timing a timeout period; and
means for activating the delayed-disablement means upon the speaking detector detecting a user speaking whilst the apparatus is initially enabled by the initial-enablement means;
the delayed-disablement means, when activated, being operative to keep the apparatus enabled for voice control following the touch sensor ceasing to detect that the user is touching the apparatus but only whilst the speaking detector continues to detect that the user is speaking and for the duration thereafter of the said timeout period as timed by the timing means, the delayed-disablement means being responsive to the speaking detector detecting recommencement of speaking by the user during this timeout period to reset timing of the timeout period.

14. Apparatus according to claim 11, wherein the touch sensor is arranged to detect a user touching one or more zones of the external surface of the apparatus which together occupy a substantial part of the upper part of the apparatus.

15. Apparatus according to claim 14, wherein said substantial part is at least the area of a hand.

16. Apparatus according to claim 14, wherein said one or more zones comprise one or more of the following zones intended for hand contact:
a zone along a top front edge of the apparatus;
a zone along a top side edge of the apparatus;
a zone occupying a major part of the front third of the top of the apparatus.

17. Apparatus according to claim 11, wherein the touch sensor is arranged to only register a touch having at least one predetermined non-personal characteristic.

18. Apparatus according to claim 17, wherein said at least one predetermined characteristic is a minimum touch pressure in a particular direction.

19. Apparatus according to claim 18, wherein the touch sensor comprises a switch plate mechanically configured to resist accidental activation by a user passing by the apparatus rather than approaching towards the apparatus.
